(19) United States
(12) Patent Application Publication
(10) Pub. No.: US 2025/0178181 A1
(43) Pub. Date: Jun. 5, 2025

(54) SYSTEMS, METHODS, AND APPARATUSES FOR MANUFACTURING CUSTOM BOARDS

(71) Applicant: Bad Boy Boards, LLC, Littleton, CO (US)

(72) Inventors: Brad Kellum, Castle Rock, CO (US); Ryan Doelling, Littleton, CO (US)

(73) Assignee: Bad Boy Boards, LLC, Littleton, CO (US)

(21) Appl. No.: 18/526,449

(22) Filed: Dec. 1, 2023

(51) Int. Cl. B25H 1/02; B25H 1/08; B25H 1/10

(52) U.S. Cl. CPC B25H 1/02; B25H 1/08; B25H 1/10

(57) ABSTRACT

A work bench includes: a frame comprising a flat surface and a stand, a plurality of spacers, each mounted along one of a first or a second edge of the flat surface; a plurality of securing mechanisms arranged at an elevated position above the flat surface. Each of the securing mechanisms comprising a first and a second clamp, a rod extending between the first and the second edge of the flat surface, wherein the rod extends into holes of the first and the second clamps, and wherein the first clamp is coupled to a tightening mechanism and the second clamp is slidable along the rod. The work bench is configured to enable one or more users to work on a plurality of workpieces in parallel, based on: supporting the workpieces on the rods; and securing each of the plurality of workpieces using at least one securing mechanism.

### FIELD OF THE DISCLOSURE

The present disclosure relates generally to manufacturing custom workpieces, such as cutting boards or game boards. In particular, but not by way of limitation, the present disclosure relates to systems, methods and apparatuses for manufacturing custom boards.

### DESCRIPTION OF RELATED ART

Boards, such as, but not limited to, cutting boards, charcuterie boards, and game boards are ubiquitous in the art. In some cases, boards are composed of wood, plastic, or another applicable material. Furthermore, cutting boards are often used for cutting and/or slicing food and help protect the countertop from being scratched, marred, and damaged by the knife. In some circumstances, customers may wish to customize the aesthetics of their board to give it a unique look/design. For instance, customers may wish to select one or more of the type of wood(s), pattern, a logo, an engraving (e.g., custom text), etc., for their board. However, custom boards tend to be significantly more expensive than conventional boards as each board has to be individually manufactured/assembled per customer requirements. In some instances, manufacturers of custom boards spend a significant amount of time in manufacturing and assembling each board, and as such, some manufacturers are reluctant to allow customers to custom design their boards. Furthermore, due to the time and cost involved to create each custom board, customer demand and sales of custom boards tend to be lower than their conventional counterparts. In some circumstances, the long lead time and high cost of custom boards also impacts overall customer satisfaction, which further lowers customer demand/sales.

Accordingly, there is a need for a refined system and manufacturing method for custom boards that can help enhance customer satisfaction, lower costs and/or lead time, and improve aesthetics/design of the custom board, as compared to the prior art.

The description provided in the Description of Related Art section should not be assumed to be prior art merely because it is mentioned in or associated with this section. The Description of Related Art section may include information that describes one or more aspects of the subject technology.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In some aspects, the techniques described herein relate to a work bench, including: a frame including: a flat surface; and a stand coupled to, and positioned below, the flat surface; a plurality of spacers, wherein each of the plurality of spacers is mounted along one of a first edge of the flat surface or a second, opposing edge of the flat surface; a plurality of securing mechanisms, wherein each of the plurality of securing mechanisms is arranged at an elevated position with respect to the flat surface, and wherein each of the plurality of securing mechanisms includes: a plurality of clamps, including at least a first clamp and a second clamp; a rod extending between the first edge of the flat surface and the second, opposing edge of the flat surface, wherein the rod is shaped and sized to extend into a hole in each of the first and the second clamps; wherein the first clamp is coupled to a tightening mechanism and the second clamp is slidable along a length of the rod; and wherein the work bench is configured to enable one or more users to work on a plurality of workpieces in parallel, based at least in part on: supporting the plurality of workpieces on the plurality of rods; and securing each of the plurality of workpieces between at least the first clamp and the second clamp of a respective securing mechanism.

In some aspects, the techniques described herein relate to a work bench, wherein securing each of the plurality of workpieces further includes: positioning a respective workpiece such that at least one first clamp of at least one of the plurality of securing mechanisms abuts a first surface of the workpiece; sliding at least one second clamp of the at least one of the plurality of securing mechanisms such that the at least one second clamp abuts a second surface of the workpiece; and adjusting at least one tightening mechanism coupled to the at least one first clamp to apply pressure on the respective workpiece in a direction that is substantially parallel to the flat surface of the work bench.

In some aspects, the techniques described herein relate to a work bench, wherein each of the plurality of spacers is positioned underneath one of a first angle iron and a second angle iron, and wherein the first angle iron is arranged along the first edge of the flat surface and the second angle iron is arranged along the second edge of the flat surface.

In some aspects, the techniques described herein relate to a work bench, wherein each of the plurality of securing mechanisms is coupled at one end to the first angle iron and at a second, opposing end to the second angle iron.

In some aspects, the techniques described herein relate to a work bench, wherein the flat surface is substantially rectangular in shape and further includes: a third edge; and a fourth edge opposing the third edge. In some embodiments, the first edge and the second edge may have the same or similar length, and the third edge and the fourth edge may have the same or similar length. In some cases, the first and second edges may be longer than the third and fourth edges. Alternatively, the third and fourth edges may be longer than the first and second edges. In yet other cases, the flat surface of the work bench may be substantially square in shape, in which case the first, second, third, and fourth edges may have the same or similar length.

In some aspects, the techniques described herein relate to a work bench, wherein the plurality of securing mechanisms include a plurality of pipe clamps extending between the first and second edges of the flat surface.

In some aspects, the techniques described herein relate to a work bench, wherein the plurality of pipe clamps are oriented in a direction that is substantially parallel to the third and fourth edges of the flat surface.

In some aspects, the techniques described herein relate to a work bench, wherein the spacers are configured to provide sufficient clearance between the flat surface and a respective underside of one or more of the plurality of workpieces to enable one or more vertically oriented clamps to apply downward pressure on the one or more workpieces.

In some aspects, the techniques described herein relate to a work bench, wherein the one or more vertically oriented clamps include one or more C-clamps, G-clamps, and G-cramps.

In some aspects, the techniques described herein relate to a work bench, where supporting the plurality of workpieces on the plurality of rods further includes: supporting a first workpiece on at least a first rod and a second rod of the plurality of rods; supporting a second workpiece on at least the first rod and the second rod of the plurality of rods; supporting a third workpiece on at least a third rod and a fourth rod of the plurality of rods; and supporting a fourth piece on at least a fifth rod and a sixth rod of the plurality of rods.

In some aspects, the techniques described herein relate to a work bench, wherein: the first workpiece and the second workpiece are positioned adjacent different ones of the first and the second edges of the flat surface; the third workpiece is adjacent one of the first or the second workpiece; and at least two of the first, second, third, and fourth workpieces have different dimensions.

In some aspects, the techniques described herein relate to a method for forming workpieces, including: providing a plurality of slats; arranging the plurality of slats on a work bench, the work bench including: a flat surface; a plurality of securing mechanisms configured to extend between two opposing edges of the flat surface, wherein each of the plurality of securing mechanisms includes a rod and a plurality of clamps; and a clearance or gap between the flat surface and the plurality of securing mechanisms; applying an adhesive on at least one surface of each of the plurality of slats; affixing, based on applying the adhesive, each of the plurality of slats to at least one adjacent slat to form an intermediate workpiece; applying pressure on the intermediate workpiece using the plurality of securing mechanisms; and processing the intermediate workpiece to form a finished workpiece, wherein the processing is based at least in part on applying the pressure on the intermediate workpiece, and wherein the processing includes at least: processing the intermediate workpiece through one or more of a planer, a sander, and a jointer planer.

In some aspects, the techniques described herein relate to a method, wherein the finished workpiece is composed of one or more types of wood, and wherein the finished workpiece includes one of a cutting board, a charcuterie board, a rolling tray, a pastry board, and a game board.

In some aspects, the techniques described herein relate to a method, wherein processing the intermediate workpiece further includes treating the intermediate workpiece; and smoothing or sanding down the intermediate workpiece, based at least in part on the treating.

In some aspects, the techniques described herein relate to a method, wherein: the intermediate workpiece is composed of one or more types of wood; the intermediate workpiece is treated a plurality of times, and wherein the treating including applying a mixture of water and oil on one or more surfaces of the intermediate workpiece; and the intermediate workpiece is smoothed or sanded down after each treatment.

In some aspects, the techniques described herein relate to a method, wherein a different grit or roughness level is utilized to smooth or sand down the intermediate workpiece after each treatment.

In some aspects, the techniques described herein relate to a method, further including smoothing or sanding down the intermediate workpiece using a coarser grit before a finer grit.

In some aspects, the techniques described herein relate to a method, wherein the treatment allows grains of wood on the intermediate workpiece to rise, and wherein the smoothing or sanding down after each treatment assists in creating a smooth finish on the finished workpiece by scraping the raised grains of wood on the intermediate workpiece.

In some aspects, the techniques described herein relate to a system configured for manufacturing custom workpieces, including: one or more hardware processors configured by machine-readable instructions to: receive a work order from a customer, wherein the work order includes information pertaining to a plurality of slats of a custom workpiece, the information including: an indication of a number of slats; an indication of a type of material for each slat of the plurality of slats; and a desired pattern, wherein the desired pattern corresponds to an arrangement of the plurality of slats; assemble an intermediate workpiece, based at least in part on receiving the work order, wherein the assembling includes: arranging the plurality of slats on a work bench, based on the desired pattern; applying an adhesive on at least one surface of each of the plurality of slats; and affixing, based on applying the adhesive, each of the plurality of slats to at least one adjacent slat to form the intermediate workpiece; apply pressure on the intermediate workpiece using a plurality of securing mechanisms; and process the intermediate workpiece to form a finished workpiece, wherein the processing is based at least in part on applying the pressure on the intermediate workpiece, and wherein the processing includes at least: processing the intermediate workpiece through one or more of a planer, a sander, and a jointer planer.

In some aspects, the techniques described herein relate to a system, wherein the finished workpiece includes one of a cutting board, a charcuterie board, a rolling tray, and a game board, and wherein each of the plurality of slats is composed of wood, and wherein receiving the indication of the type of material for each slat of the plurality of slats includes: receiving an indication of a type of wood for each of the plurality of slats, wherein the type of wood is selected from a group consisting of sapele, maple, hickory, cherry, padauk, purpleheart, and walnut.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a top view of a system for manufacturing custom workpieces, according to various aspects of the present disclosure.

FIG. 2 illustrates a side view of the system in FIG. 1, according to various aspects of the present disclosure.

FIG. 3A illustrates a side view of an adjustable securing mechanism configured for use with the systems in FIGS. 1 and/or 2, according to various aspects of the disclosure.

FIG. 3B illustrates a side view of another adjustable securing mechanism configured for use with the systems in FIGS. 1 and/or 2, according to various aspects of the disclosure.

FIG. 4 illustrates an example of a process flow for manufacturing custom workpieces, such as custom cutting boards or game boards, according to various aspects of the disclosure.

FIG. 5 illustrates an example of a method for manufacturing custom workpieces, according to various aspects of the disclosure.

FIG. 6 illustrates an example of a method for automated manufacturing of custom workpieces, according to various aspects of the disclosure.

FIG. 7 illustrates an example of a computer system that can be configured to effectuate one or more aspects of the present disclosure.

FIG. 8 illustrates an example of a system configured for custom manufacturing of workpieces, such as cutting boards, according to various aspects of the disclosure.

### DETAILED DESCRIPTION

The present disclosure relates generally to custom manufacturing of workpieces, such as, but not limited to, cutting boards and game boards (e.g., chess boards, checkers boards, etc.). More specifically, but without limitation, the present disclosure relates to system, methods, apparatuses, and storage media for manufacturing custom boards.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

As used herein, the term “board” may refer to a functional or utilitarian board and/or a decorative board. Some non-limiting examples of boards discussed herein may include a cutting board (e.g., a wooden cutting board used for culinary purposes), a charcuterie board, a game board (e.g., a chess board, a checkers board), or any other applicable board.

As used herein, the term “custom workpiece” can be used to refer to any of a custom-designed (or custom-made) cutting board, game board, wall clock, pastry board, dough rolling board, and/or rolling tray (e.g., for hand rolling cigarettes or another smokeable item), to name a few non-limiting examples.

As used herein, the terms “board”, “custom board”, “workpiece”, “cutting board”, and “custom workpiece” may be used interchangeably throughout the disclosure. Furthermore, the terms “clamp”, “adjustment mechanism”, “securing mechanism” and “adjustable securing mechanism” may be used interchangeably throughout the disclosure.

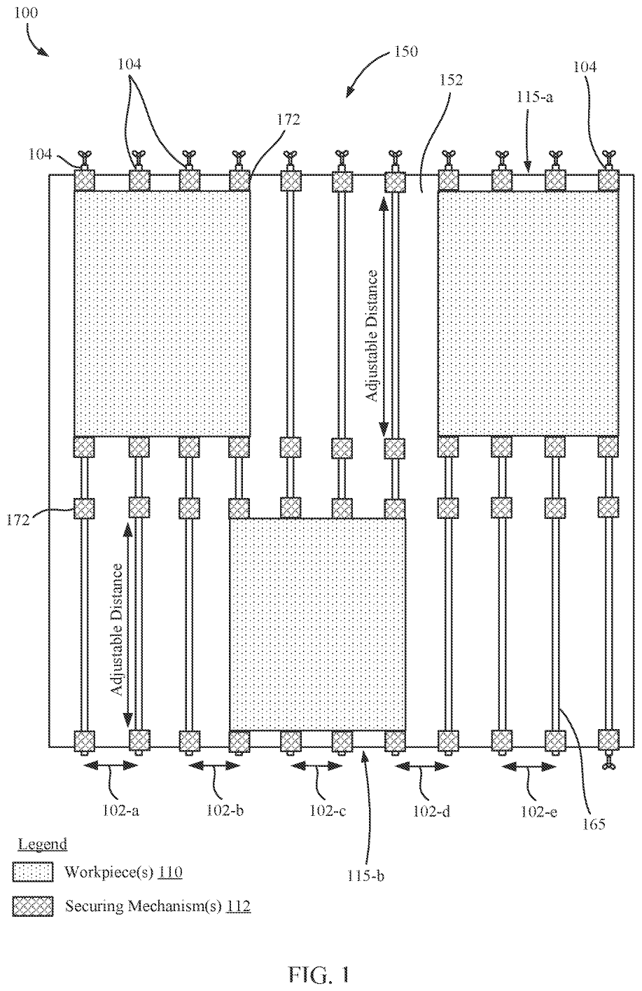

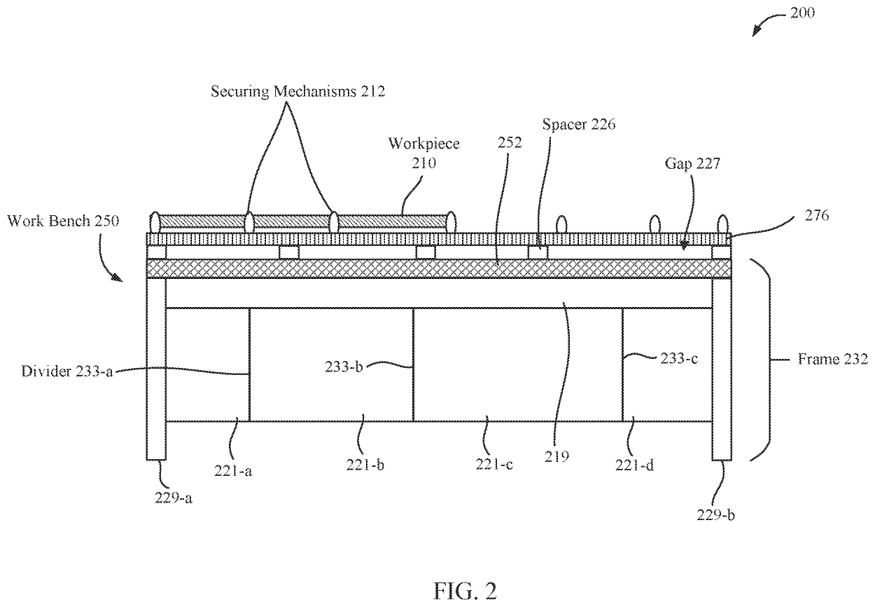

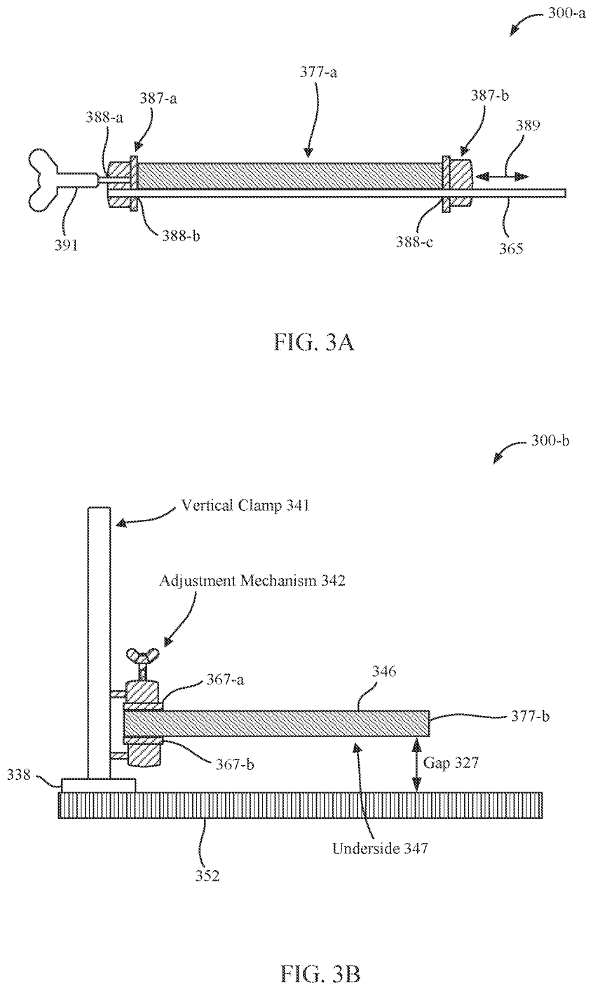

Turning now to FIG. 1, which illustrates a top view of a system 100 for manufacturing custom workpieces, according to various aspects of the disclosure. As seen, the system 100 comprises a work bench 150 and a plurality of adjustable securing mechanisms 112 (or simply, securing mechanisms 112). In some embodiments, the plurality of securing mechanisms may include pipe clamps, C-clamps, G-clamps, and/or G-cramps, although other types of securing mechanisms and/or clamps are also contemplated in different embodiments. In this example, the securing mechanisms 112 (e.g., securing mechanism or pipe clamp described with reference FIG. 3A) include a plurality of rods 165 and a plurality of clamps 172 (also shown as clamps 387 in FIG. 3A), where each rod 165 is shaped and sized to pass through a through-hole (e.g., hole(s) 388 in FIG. 3A) in one or more clamps 172. In some cases, the work bench 150 further comprises a frame (e.g., shown as frame 232 in FIG. 2), where the frame comprises a plurality of legs (e.g., legs 229-a, 229-b in FIG. 2). In some cases, the frame (also referred to as stand 232) supports a flat working surface 152, where the flat working surface 152 is mounted on a top/upper portion of the frame (more clearly visible in FIG. 2).

In some embodiments, the work bench 150 of FIG. 1 can be designed to enable a user to work on multiple workpieces 110 in parallel, which can help reduce time and/or cost for manufacturing custom boards, as compared to the prior art. For example, the plurality of securing mechanisms 112 comprising the plurality of rods 165 and the plurality of clamps 172 can allow a user to secure multiple unfinished workpieces 110 over the flat surface 152 of the work bench. In some cases, each workpiece 110 can be secured between two or more clamps/jaws 172 of one or more securing mechanisms 112. In some instances, each clamp (e.g., clamp 387-a, clamp 387-b in FIG. 3A) comprises a jaw, where the jaw is designed to abut an exterior surface of the workpiece and help hold the unfinished workpiece in place on the work bench. Furthermore, at least one of the clamps 172 of each securing mechanism 112 can include a rotatable handle 104 (or windage knob/handle 104), while another of the clamps 172 of each securing mechanism 112 can be slidable/movable along the length of the respective rod 165. In this example, the clamps 172 with the rotatable handles 104 are positioned toward one of the edges 115 (e.g., edge 115-a, 115-b) of the flat surface 152, while the slidable clamps 172 are positioned towards the center of the flat surface 152. However, it should be noted that this arrangement of the clamps is not intended to be limiting and other arrangements are contemplated in different embodiments. In one non-limiting example, the slidable clamps can be arranged closer to the edges (e.g., edge 115-a or edge 115-b) of the flat surface 152, while the clamps with the rotatable handles 104 can be arranged towards the center of the flat surface 152. In some cases, the separation 102 between the securing mechanisms (e.g., pipe clamps) may be the same or substantially the same. In other cases, one or more of the separation 102 distances may be different. For instance, separation distance 102-a and 102-b may be the same or substantially the same (e.g., ˜8 inches), while separation distances 102-c, 102-d, and 102-e may be the same or substantially the same (e.g., ˜12 inches). It should be noted that the separation distances listed herein are exemplary only and not intended to limit the scope and/or spirit of the present disclosure.

In some cases, the distance between two opposing clamps of a rod may be adjustable, as depicted in FIG. 1. For example, after placing a workpiece 110 on a plurality of rods 165, the workpiece 110 can be secured between a plurality of respective clamps, where the securing may include tightening the rotatable handles 104 of one or more clamps 172 such that their jaws abut one side of the workpiece and/or sliding one or more clamps 172 along the rods 165 such that their jaws abut another side of the workpiece. In some aspects, securing the workpiece 110 using the plurality of securing mechanisms (e.g., pipe clamps) helps apply a horizontal pressure (i.e., in a direction parallel to the rods 165 and/or the flat surface 152) on the workpiece, which can help affix the individual slats/panels of the workpiece, further described with reference to FIGS. 3A-B and/or 4.

The example in FIG. 1 depicts three workpieces 110 on the work bench 150; however, the number of workpieces 110 is not intended to be limiting. In other cases, more than 3 workpieces (e.g., 6 workpieces, 8 workpieces, 12 workpieces, etc.) can be worked on in parallel using a single work bench 150, which can allow one or more users to manufacture multiple custom-designed workpieces simultaneously, thereby enhancing efficiency, production output, etc., as compared to the prior art.

In some cases, the dimensions (e.g., width, length, and/or height) of the work bench 150 may be based on the size of the facility or factory floor where it will be utilized. In some cases, the work bench 150 can be rectangular in shape, or alternatively, square in shape. In some cases, multiple work benches can be arranged side-by-side and coupled to each other using any attachment or coupling means known in the art. In one non-limiting example, the length (e.g., distance between the opposing edges 115-a and 115-b) of the work bench 150 may be at least 30 inches (e.g., 31 inches, 36 inches or 3 feet, 40 inches, etc.). Furthermore, the width of the work bench 150, for instance, the distance between the other two opposing edges (e.g., left and right edges of work bench 150 in the figure), may be equal to or greater than the length of the work bench 150. In some examples, the width of the work bench 150 may be at least 6 feet, at least 8 feet, or anywhere between 10-12 feet, to name a few non-limiting examples. In yet other cases, the work bench 150 may have a square shape, in which case its length may be equal to its width. In some cases, the distance between the flat surface 152 and the floor may be at least 3 feet, for instance, anywhere between 3.5 to 4.5 feet. In other words, the height of the frame (e.g., frame 232 in FIG. 2) may be at least 3 feet, in some embodiments. It should be noted that the illustration in FIG. 1 is not necessarily drawn to scale, and other ratios of width to length for the work bench 150 are contemplated in different embodiments.

FIG. 2 illustrates a side view of a system 200, according to various aspects of the disclosure. The system 200 may be similar or substantially similar to the system 100, previously described in relation to FIG. 1. As seen, the system 200 comprises a work bench 250, where the work bench 250 includes a frame 232 and a flat surface 252 positioned on a top/upper portion of the frame 232. The frame 232 further includes a plurality of legs 229-a, 229-b that extend from the underside of the flat surface 252 to the ground or floor. In some embodiments, the frame 232 may further include one or more storage areas that can be used to store tools, adhesives (e.g., glue), or any other applicable materials used for the manufacture of the custom workpieces. For example, FIG. 2 depicts a first storage area 219 positioned between the legs 229-a and 229-a and directly underneath the flat surface 252. FIG. 2 also depicts a plurality of additional storage areas 221 positioned between the legs 229-a and 229-b and underneath the first storage area 219. For instance, FIG. 2 depicts a storage area 221-a, a storage area 221-b, a storage area 221-c, and a storage area 221-d, and a plurality of dividers 233 separating adjacent storage areas (e.g., a divider 233-a separating storage areas 221-a and 221-b, a divider 233-b separating storage areas 221-b and 221-c, and a divider 233-c separating storage areas 221-c and 221-d). In this example, first storage area 219 spans the cumulative width of storage areas 221-a through 221-d but is shorter in height than any of the storage areas 221. In some instances, storage areas 221-a through 221-d may have the same or similar dimensions (e.g., width, height, and/or depth). Alternatively, one or more of the storage areas (e.g., storage areas 221-b, 221-c) may be wider than one or more of the other storage areas (e.g., storage areas 221-a, 221-d). It should be noted that other configurations (e.g., relative dimensions, position with respective to the flat surface 252, etc.) of storage areas 219 and 221 are contemplated in different embodiments, and the examples discussed herein are not intended to limit the scope and/or spirit of the present disclosure.

In some cases, the system 200 may further include a plurality of spacers 226 positioned on the top/upper side of the flat surface 252, which can help provide a clearance or gap 227 between the top/upper side of the flat surface 252 and the underside of the workpiece 210. In some cases, the clearance or gap 227 may be shaped and sized to enable a user to position one or more additional securing mechanisms (e.g., vertical clamp 341 shown in FIG. 3B) on the work bench, which can help provide a more secure hold on the workpiece 210, apply vertical or downwards pressure on the workpiece 210 (i.e., in addition to the horizontal pressure provided by the pipe clamps discussed in relation to FIG. 1), or a combination thereof. In one non-limiting example, the clearance or gap 227 may be around 1.5 inches, although other distances are also contemplated in different embodiments. For example, the clearance or gap 227 may be around 1 inch, anywhere between 2-4 inches, at least 3 inches, to name a few non-limiting examples. In some instances, the securing mechanisms 212 (e.g., pipe clamps) can be used to secure the workpiece 210 at an elevated position above the flat surface 252. In some cases, the securing mechanisms 212 may be coupled (e.g., welded, coupled using screws/rivets, etc.) to an angle iron 276, where the angle iron 276 is positioned atop the spacers 226. In some cases, the angle iron 276 can also be coupled to the spacers 226, e.g., using screws, nails, etc. In some cases, the number of spacers 226 may be equal or substantially equal to the number of securing mechanisms 212 (or rods/pipes of the pipe clamps). In other cases, the system 200 may include a greater number of spacers 226 than securing mechanisms 212 or vice versa. Furthermore, the separation distance between adjacent spacers 226 may be the same or substantially the same, in some embodiments. Alternatively, the separation distance between adjacent spacers 226 may be equal or substantially equal to the separation distance between adjacent rods or pipes of the securing mechanisms 212 (or pipe clamps). In one non-limiting example, the distance (e.g., measured from center-center) between adjacent spacers 226 may be at or around 4 inches, although other distances are also contemplated in different embodiments. In some examples, securing mechanisms 212 may be spaced (e.g., measured from center-center of adjacent securing mechanisms or pipe clamps 212) around 5 inches apart. In some other cases, the distance between adjacent spacers 226 may be roughly the same as the distance between adjacent securing mechanisms, for instance, 4 inches, 4.5 inches, or 5 inches, to name a few. It should be noted that, the variants and configurations described herein are exemplary only, and other variants/configurations of the spacers, securing mechanisms, angle iron, etc., are contemplated in different embodiments. Similar to FIG. 1, it should be noted that the illustration in FIG. 2 is not necessarily drawn to scale. For example, the relative dimensions of the height of the work bench 250, the height of the frame 232, and/or the separation between legs 229-a and 229-b may or may not be drawn to be scale in FIG. 2.

Furthermore, since FIG. 2 depicts a side view of the system 200, only one of the angle iron(s) 276 is visible from this angle. In some cases, the system 200 may comprise a plurality of angle irons positioned on (or along) a plurality of edges of the work bench 150. For instance, angle iron 276 may be positioned along one edge (e.g., edge 115-a in FIG. 1) of the work bench (e.g., work bench 150, 250), while another angle iron (e.g., similar to angle iron 276) may be positioned along the opposing edge (e.g., edge 115-b) of the work bench (e.g., work bench 150).

FIG. 3A depicts a cross-sectional view of a work bench 300-a, according to various aspects of the disclosure. The work bench 300-b may implement one or more aspects of the work bench 150 and/or work bench 250 described above with reference to FIG. 1 and/or, respectively. In this example, a workpiece 377-a is secured over the horizontal or flat surface of the work bench 300-a using a securing mechanism, such as a pipe clamp. For sake of illustration, the horizontal or flat working surface of the work bench 300-a is not shown in FIG. 3A. However, FIG. 3B depicts another view of a work bench 300-b showing a flat surface 352, and a workpiece 377-b secured over the flat surface 352.

As seen in FIG. 3A, the pipe clamp comprises a rod 365 (also referred to as pipe 365) positioned underneath the workpiece, where the rod 365 serves as a base for supporting the workpiece 377-a over the flat surface (e.g., flat surface 352 in FIG. 3B) of the work bench 300-a. The pipe clamp further comprises a first clamp 387-a (or first jaw 387-a) having a rotatable handle 391 and a second clamp 387-b (or second jaw 387-b), where the second clamp 387-b is oriented to face the first clamp 387-a. In some cases, the second clamp 387-b may be slidable along the length of the rod 365, as shown by arrow 389.

As shown in FIG. 3A, the pipe clamp may also include one or more through-holes 388. For instance, the rotatable handle 391 may be coupled or secured to the first clamp/jaw 387-a via a windage screw, where the windage screw is received in an opening/hole 388-a of the jaw 387-a. Furthermore, the rod 365 may be shaped and sized to partially extend into (or pass through) a hole 388-b in the first clamp 387-a and a hole 388-c in the second clamp 387-b. In some cases, the holes 388-b and 388-c may be aligned with each other when the system is assembled, which allows the rod/pipe of the pipe clamp to pass through both the holes 388-b, 388-c. In some embodiments, the rotatable handle 391 (or windage knob/handle 391) coupled to the first clamp/jaw 387-a can be rotated to apply a horizontal pressure (i.e., in the same direction as, or parallel to, the arrow 389) once the workpiece 377-a is positioned between the two opposing clamps/jaws 387-a and 387-b. In one non-limiting example, a user can place the unfinished workpiece 377-a on the rods 365 of the pipe clamps, position the workpiece 377-a such that the flat surfaces of the first jaws 387-a abut one side of the workpiece, slide the second jaws 387-b along their respective rods 365 such that their flat surfaces abut an opposing side of the workpiece 377-a, lock the second jaws 387-b in place on their respective rods, and rotate the respective handles 391 of the pipe clamps until a sufficient horizontal pressure is applied on the workpiece 377-a by the jaws 387-a, 387-b of the pipe clamps.

While FIG. 3A only depicts one securing mechanism or pipe clamp, it should be noted that multiple securing mechanisms or pipe clamps can be employed to secure a single workpiece, as previously described in relation to FIGS. 1-2. Furthermore, FIG. 3A only depicts a partial length of the rod and a single pair of jaws/clamps 387-a, 387-b. In other cases, however, the rod 365 can pass through (or interface with) more than one pair of jaws/clamps. For example, the rod 365 can include a second pair of jaws/clamps (e.g., on the right side of the jaw 387-b in FIG. 3A), where the second pair includes a jaw/clamp (e.g., similar to the jaw 387-b) positioned closer to the jaw 387-b and another jaw/clamp (e.g., similar to the jaw 387-a) positioned further away from the jaw 387-b. Additionally, a second workpiece can be positioned between this second pair of jaws/clamps. FIG. 1 depicts a clearer illustration of a plurality of pairs of clamps/jaws 172 interfacing with a single rod 165. In this way, aspects of the present disclosure can allow one or more user(s) to work on multiple workpieces in parallel.

FIG. 3B depicts a side view of a work bench 300-b, according to various aspects of the disclosure. The work bench 300-b may be similar or substantially similar to any of the work benches described herein, including at least the work bench 300-a described with reference to FIG. 3A. As described in relation to FIG. 2, in some cases, the work bench can include one or more mechanisms (e.g., angle iron, spacers, or any other applicable mechanism) that facilitate in providing a clearance or gap 327 between the underside 347 of the workpiece 377-b and the flat surface 352 of the work bench 300-b. In some cases, the clearance or gap 327 may be fixed (i.e., non-adjustable). Alternatively, the gap 327 can be adjustable. For example, a plurality of vertical rails (or sliding mechanisms) may be provided, where one end of each vertical rail is coupled to a base of an angle iron, while the other end is coupled to the flat surface (e.g., flat surface 252 in FIG. 2) and/or frame (e.g., frame 232 in FIG. 2) of the work bench (e.g., work bench 250, work bench 300-b). Each of the vertical rails (or sliding mechanisms) can be positioned within a hollow channel and movable within the respective hollow channel to allow a user to adjust the clearance or gap 327 between the flat surface 352 of the work bench 300-b and the underside 347 of the workpiece 377-b. In another non-limiting example, the gap/clearance adjustment mechanism may include a plurality of arms, for instance, a first pair of arms connected to the first angle iron and a second pair of arms connected to the second angle iron. Furthermore, the first and second pair of arms may also be connected to the flat surface 352 or frame of the work bench. In some cases, the arms of the first pair of arms may connect at a first pivot point and the arms of the second pair of arms may connect to a second pivot point, where the first and second pivot points allow a “scissoring motion” to be created to raise and lower the first and second angle irons (i.e., welded or coupled to the pipe clamps) with respect to the flat surface of the work bench 300-b. FIG. 2 depicts an illustration of an angle iron 276 positioned along one edge (e.g., edge 115-a in FIG. 1) of a work bench 250. It should be noted that, in some embodiments, another angle iron (e.g., similar to angle iron 276) may be positioned along the opposing edge (e.g., edge 115-b) of the work bench. Other clearance or gap mechanisms for dynamic adjustment of the gap 327 between the underside 347 of the workpiece 377-b and the flat surface 352 are contemplated in different embodiments and the examples listed herein are not intended to be limiting. In some cases, the vertical rails or pivoting arms described above can be coupled to an electric motor, which can help a user easily adjust the separation or gap 327.

In some examples, the gap 327 allows a user to position one or more other securing/adjustment mechanisms to secure the workpiece 377-b in place on the work bench 300-b. For example, in some circumstances, a user may wish to apply both horizontal and vertical pressure on the workpiece 377-b during the manufacturing process. As shown in FIG. 3B, a vertical clamp 341 having a base 338 and an adjustment mechanism 342 can be positioned on the flat surface 352 of the work bench 300-b. The adjustment mechanism 342 may include a plurality of opposing jaws 367 (e.g., jaw 367-a, jaw 367-b) that can abut the topside 346 and underside 347 of the workpiece 377-b and facilitate in applying a vertical pressure on the workpiece 377-b, securing the workpiece 377-b in a flat or substantially flat position over the work bench 300-b, and/or preventing tilting or a rolling motion of the workpiece 377-b. In some embodiments, the vertical clamp 341 may be an example of a G clamp, a C clamp, or any other applicable type of clamp known in the art.

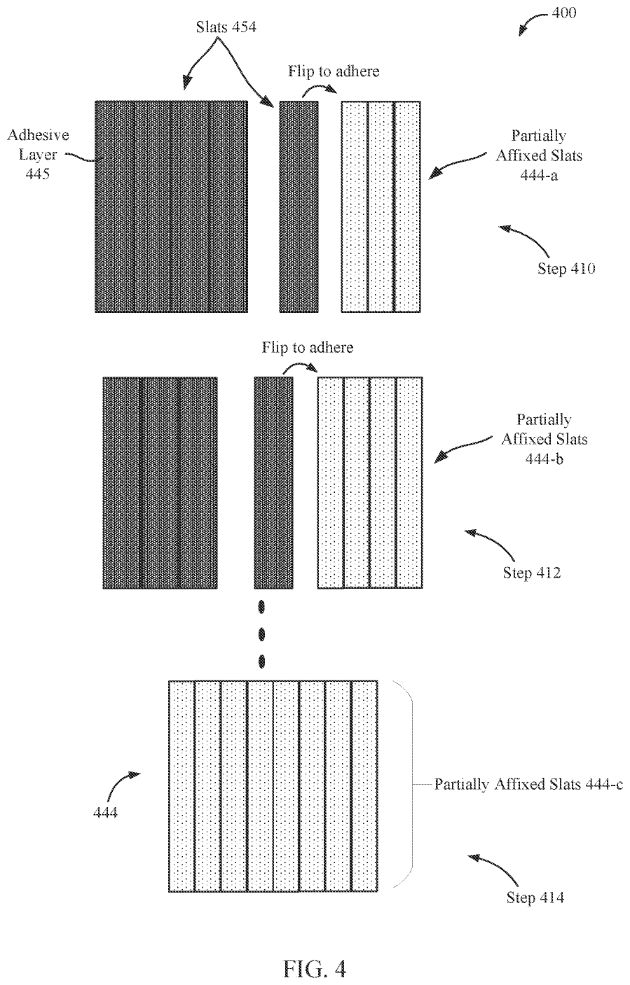

FIG. 4 illustrates an example of a process flow 400 for manufacturing custom workpieces, such as custom cutting boards or game boards, according to various aspects of the disclosure. In some embodiments, the workpieces (e.g., workpiece(s) 110 in FIG. 1, workpieces 377 in FIGS. 3A-B) may be manufactured by adhering together a plurality of slats or panels (e.g., wooden slats or panels), which enables a user to manufacture custom-designed workpieces based on customer specifications. In some instances, the wooden slats or panels of a workpiece (e.g., cutting board, game board, rolling tray, etc.) may be composed of the same type of wood (e.g., having different arrangement or patterns of wood grains/fibers). Alternatively, multiple types of wood (e.g., mahogany, ebony, teak, etc.) can be used for the different slats or wood panels. As an example, a custom-designed cutting board can comprise eight (8) panels, with 3 panels of a first type of wood (e.g., mahogany), 2 panels of a second type of wood (e.g., cherrywood), and 2 panels of a third type of wood (e.g., cedar), where the panels can be arranged according to customer specifications.

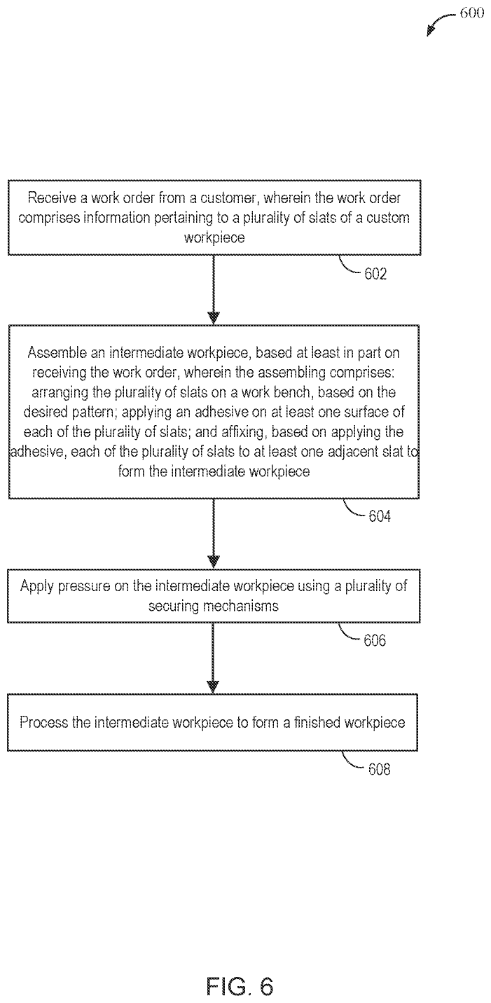

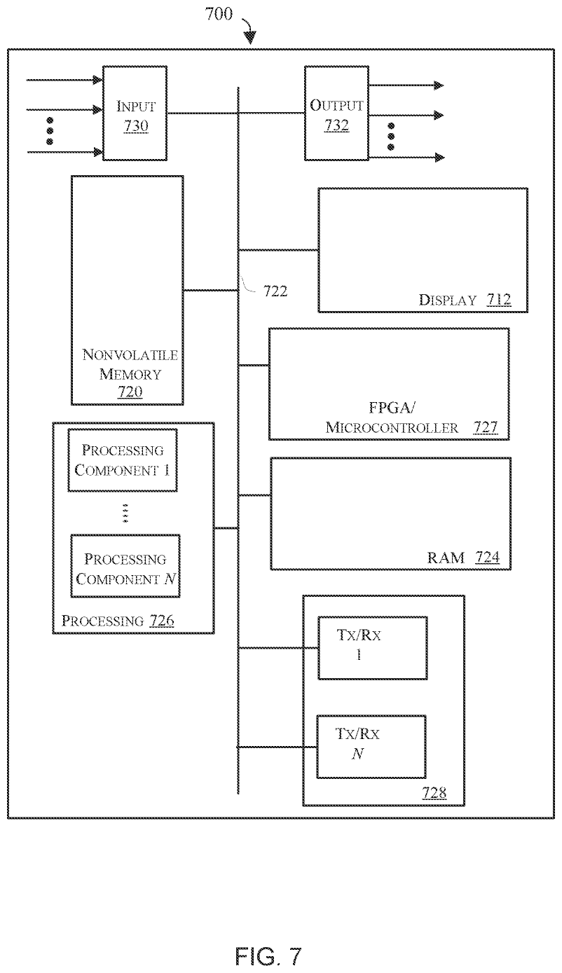

In some cases, the various steps shown in FIG. 4 can be performed by a user on any of the work benches described above in relation to FIGS. 1, 2, and/or 3A-B. Additionally, or alternatively, one or more of the steps 410-414 can be performed using an automated work bench with minimal to no user input, further described below in relation to FIGS. 6, 7, and/or 8. For sake of brevity, FIG. 4 does not depict an individual step/operation for how each panel/slat is adhered or affixed to the partially affixed slats but is intended to provide the necessary understanding for manufacturing an intermediate workpiece 444 (i.e., prior to additional processing to form a finished workpiece), in accordance with aspects of the present disclosure. In some cases, the term “intermediate workpiece” may be used to refer to an unfinished or partially finished workpiece. For example, an intermediate workpiece 444 may undergo additional processing (e.g., using a sander, planer, and/or jointer planer, treatment with an oil-water mixture, etc.) to smooth down the exterior surface of the workpiece 444.

In this example, a plurality of slats 454 and partially affixed slats 444-a are initially positioned over the rods/pipes (e.g., rod(s) 165 in FIG. 1) of the pipe clamps (e.g., securing mechanism(s) 112 in FIG. 1). In some embodiments, an adhesive layer 445 (e.g., glue) can be applied to one or more exterior surfaces of each slat or panel 454. As seen, a first step 410 can comprise flipping a first slat 454 such that one of its exterior surfaces (e.g., exterior surface with the adhesive layer 445) faces an exterior surface of one slat/panel (e.g., leftmost slat) of the partially affixed slats 444-a. The first slat 454 can then be adhered to the partially affixed slats 444-a. For instance, step 410 depicts three (3) partially affixed slats 444-a, while step 412 depicts four (4) partially affixed slats 444-b. In some cases, steps 410 and 412 can be repeated until all the slats 454 are adhered (step 414) to produce the intermediate workpiece 444. In this example, the intermediate workpiece 444 comprises eight partially affixed slats 444-c. However, the number of slats is not intended to be limiting. For example, different workpieces can comprise a different number of slats (e.g., a small cutting board can comprise 4 slats, a medium sized cutting board can comprise 8 slats, while a large cutting board can comprise 16 slats).

In some cases, a horizontal pressure can be applied on the intermediate workpiece 444 using a plurality of pipe clamps, i.e., as described in relation to FIGS. 1 and 3A, to help adhere or join adjacent slats. In some cases, the horizontal pressure can be applied for a pre-defined duration of time (e.g., at least 30 minutes, at least 1 hour, at least 2 hours, etc.). Furthermore, process 400 can also comprise applying vertical pressure on the intermediate workpiece 444, for instance, using the vertical clamp 341 described in relation to FIG. 3B. It should be noted that, the intermediate workpiece 444 may remain on the work bench (e.g., work bench 150 in FIG. 1, work bench 300-a in FIG. 3A) for the entire duration when the horizontal and/or vertical pressure is applied, which facilitates in creating a unitary custom workpiece.

In some cases, after sufficient horizontal and/or vertical pressure is applied to secure the slats/panels of the intermediate workpiece 444, the intermediate workpiece 444 may undergo additional processing to form a finished custom workpiece (e.g., a custom cutting board or game board that can be sold to the customer). In some cases, the additional processing may comprise processing the intermediate workpiece 444 through one or more of a planer, a sander, and a jointer planer to smooth the exterior surfaces of the wood slats/panels of the workpiece. In one non-limiting example, the intermediate workpiece 444 can be processed (e.g., passed through) using one or more of a planer and a jointer planer before it is passed through a sander. Alternatively, the intermediate workpiece 444 can be processed using a planer and a sander, in which case no jointer planer may be utilized. In yet other cases, the intermediate workpiece 444 can be processed using a jointer planer and a sander, in which case no planer may be utilized. It should be noted that, other processing techniques using different types of equipment other than those listed herein are contemplated in different embodiments and the examples listed herein are not intended to limit the scope and/or spirit of the present disclosure. Furthermore, while the present disclosure generally describes custom-designed wooden workpieces, this is in no way intended to be limiting. For instance, aspects of the present disclosure can be employed to manufacture and process workpieces composed of other materials besides wood (e.g., wood plastic composite, bamboo, hemp, cork, fiber cement, and concrete, to name a few non-limiting examples).

In some embodiments, processing the intermediate workpiece 444 may further comprise treating the intermediate workpiece 444 one or more times, further described below. For example, if the intermediate workpiece 444 is composed of one or more types of wood, the intermediate workpiece 444 can be treated a plurality of times using a mixture of oil and water, where the treating can comprise applying an oil-water mixture on one or more exterior surfaces of the intermediate workpiece 444. In some cases, the oil-water mixture can be sprayed, or alternatively, applied by hand onto each exterior surface of the intermediate workpiece 444. This helps provide an even coating of the oil-water mixture on the exterior surfaces of the intermediate workpiece 444. In some instances, this treatment helps in raising the grains of the wood, which can subsequently be smoothed or sanded down to provide a smooth texture/finish to the finished workpiece. In some embodiments, the workpiece 444 can be smoothed or sanded down between treatments, for instance, using a different roughness or grit. In one non-limiting example, a coarser grit may be used before a finer grit. For instance, a first grit (e.g., a coarser grit sandpaper) may be utilized to smooth/sand down the intermediate workpiece 444 after an initial oil-water mixture treatment. Next, another oil-water mixture treatment may be performed, followed by another smoothing/sanding down with a second grit (e.g., a finer grit sandpaper). In some cases, this treatment and smoothing/sanding down process can be repeated multiple times (e.g., >2 times) with different grit/roughness levels, which facilitates in enhancing quality, aesthetics, texture, etc., of the finished workpiece.

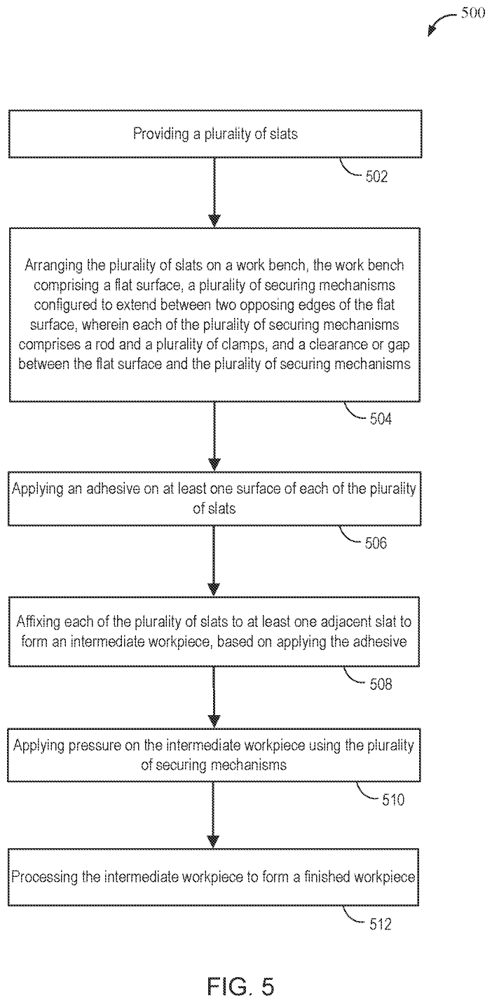

FIG. 5 illustrates an example of a method 500 for manufacturing custom workpieces, according to various aspects of the disclosure.

A first operation 502 comprises providing a plurality of slats (e.g., slats 454 in FIG. 4).

A second operation 504 comprises arranging the plurality of slats (e.g., slats 454) on a work bench (e.g., work bench 150 in FIG. 1). In some embodiments, the work bench comprises a flat surface (e.g., flat surface 152), a plurality of securing mechanisms (e.g., securing mechanisms 112) configured to extend between two opposing edges (e.g., edge 115-a, edge 115-b) of the flat surface, and a clearance or gap (e.g., gap 227 in FIG. 2) between the flat surface and the plurality of securing mechanisms. In some cases, one or more of the plurality of securing mechanisms may comprise a pipe clamp, where each pipe clamp may include a rod (e.g., rod 165) and a plurality of clamps (e.g., clamps or jaws 172).

A third operation 506 comprises applying an adhesive on at least one surface of each of the plurality of slats, as previously described in relation to the process flow 400 in FIG. 4.

A fourth operation 508 comprises affixing, based on applying the adhesive, each of the plurality of slats to at least one adjacent slat to form an intermediate workpiece.

A fifth operation 510 comprises applying pressure (e.g., horizontal pressure) on the intermediate workpiece using the plurality of securing mechanisms (or pipe clamps), as described above with reference to FIGS. 1 and/or 3A.

A sixth operation 512 comprises processing the intermediate workpiece to form a finished workpiece, wherein the processing comprises at least processing the intermediate workpiece through one or more of a planer, a sander, and a jointer planer, based at least in part on applying the pressure (e.g., horizontal) on the intermediate workpiece.

In some embodiments, the finished workpiece can be composed of one or more types of wood (e.g., each slat may be composed of wood). Some non-limiting examples of the types of wood that may be used for the slats may include sapele, maple, hickory, cherry, padauk, purpleheart, and walnut. It should be noted that other types of wood, wood composites, bamboo, and/or other applicable materials are also contemplated in different embodiments and the examples listed herein are not intended to be limiting. In some cases, the finished workpiece may be a wooden board comprising a plurality of slats or panels of one or more different types of wood. In some cases, the finished workpiece comprises one of a cutting board, a charcuterie board, a rolling tray (e.g., for rolling a smokeable item, such as a cigarette), and a game board (e.g., chess board, checkers board), although other types of boards are also contemplated in different embodiments.

FIG. 6 illustrates another example of a method 600 for manufacturing custom workpieces, according to various aspects of the disclosure. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

A first operation 602 may include receiving a work order from a customer, wherein the work order comprises information pertaining to a plurality of slats of a custom workpiece. In some cases, the information comprises an indication of a number of slats, an indication of a type of material for each slat of the plurality of slats, and a desired pattern, wherein the desired pattern corresponds to an arrangement of the plurality of slats. In some cases, the customer may transmit the work order via a user interface (UI), such as a website, accessed from a computing device (e.g., laptop, smartphone, tablet computer, or any other applicable computing platform). In some examples, the website may also display a rendering or illustration showing how the finished workpiece will look, based on the specifications input by the customer. In some embodiments, the rendering or illustration may be displayed in real-time or substantially real-time on the customer's computing device, which can help the customer easily visualize how their custom workpiece will look once manufactured.

A second operation 604 may include assembling an intermediate workpiece, based at least in part on receiving the work order, wherein the assembling comprises arranging the plurality of slats on a work bench, based on the desired pattern; applying an adhesive on at least one surface of each of the plurality of slats; and affixing, based on applying the adhesive, each of the plurality of slats to at least one adjacent slat to form the intermediate workpiece. In some cases, one or more of the individual steps of operation 604 may be performed using an automated work bench, in accordance with one or more implementations.

A third operation 606 may include applying pressure on the intermediate workpiece using a plurality of securing mechanisms (e.g., pipe clamps, vertical clamps, such as, G clamps or C clamps, or any other applicable securing mechanism). In some cases, an electrically controlled pipe clamp system can be utilized to apply a horizontal pressure on the intermediate workpiece. For example, a user can position the intermediate workpiece between opposing jaws/clamps of the electrically controlled pipe clamp system, and the pipe clamp system can automatically adjust the jaws/clamps to apply a horizontal pressure on the workpiece. In some cases, the electrically controlled pipe clamp system can be configured to automatically determine the amount of horizontal pressure to apply based on the type of workpiece, size of the workpiece, type of wood, etc. Alternatively, the user can indicate the amount of horizontal pressure that should be applied on the intermediate workpiece by the pipe clamp system.

A fourth operation 608 may include processing the intermediate workpiece to form a finished workpiece, wherein the processing comprises at least processing the intermediate workpiece through one or more of a planer, a sander, and a jointer planer, based at least in part on applying the pressure on the intermediate workpiece.

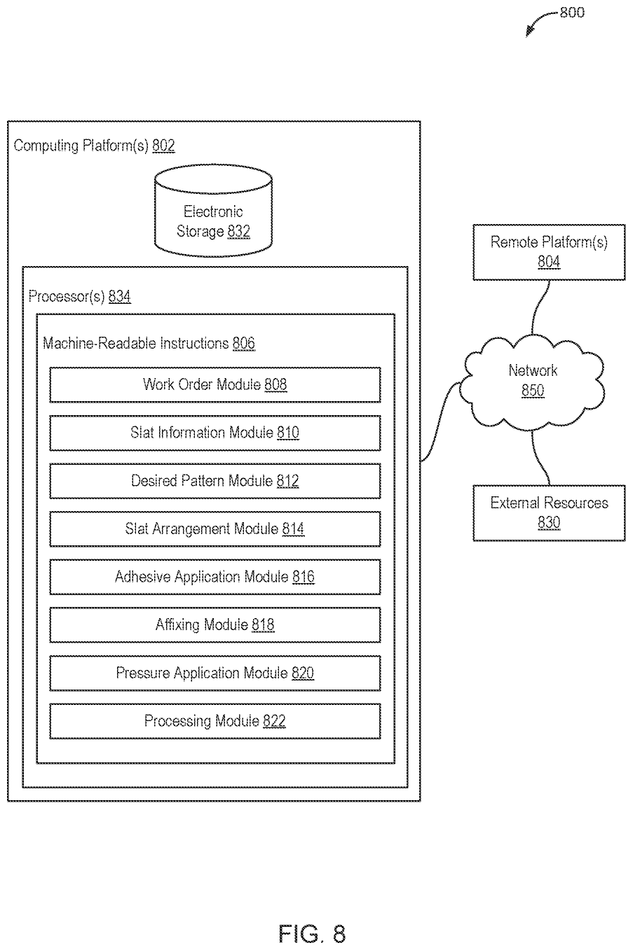

Turning now to FIG. 8, which illustrates an example of a system 800 configured for custom manufacturing of workpieces, according to various aspects of the disclosure. In some implementations, system 800 may include one or more servers 802. Server(s) 802 (also referred to as computing platforms 802) may be configured to communicate with one or more client computing platforms 804 (or remote platforms 804) according to a client/server architecture and/or other architectures. Client computing platform(s) 804 may be configured to communicate with other client computing platforms via server(s) 802 and/or according to a peer-to-peer architecture and/or other architectures. Users (e.g., customers) may access system 800 via client computing platform(s) 804. For example, a user may access a UI or website through the client computing platform 804 to input a work order, where the work order comprises one or more specifications (e.g., type of workpiece, number of slats or panels, an indication of a type of wood for each of the plurality of slats) specific to the workpiece to be manufactured.

Server(s) 802 may be configured by machine-readable instructions 806. Machine-readable instructions 806 may include one or more instruction modules. The instruction modules may include computer program modules. The instruction modules may include one or more of work order module 808, slat information module 810, desired pattern module 812, slat arrangement module 814, adhesive application module 816, affixing module 818, pressure application module 820, processing module 822, and/or other instruction modules.

Work order module 808 may be configured to receive a work order from a customer (e.g., via a UI or website displayed on a web browser and accessed from a mobile device, a laptop, a tablet, etc.). In some cases, the customer may transmit the work order to the work order module 808 (or system 800) via the computing platform 804. Furthermore, the work order may comprise information pertaining to one or more specifications of a custom workpiece (e.g., a custom-designed cutting board).

Slat information module 810 may be configured to extract, from the work order, information pertaining to a plurality of slats of the custom workpiece. In some embodiments, the information pertaining to the plurality of slats of the custom workpiece (e.g., custom cutting board, game board, etc.) may comprise an indication of a number of slats (e.g., 8 slats, 12 slats, 16 slats, etc.), an indication of a type of material for each slat of the plurality of slats, and an indication of a desired pattern/arrangement of the slats in the finished workpiece. In some cases, the desired pattern may correspond to an arrangement of the plurality of slats. As an example, the work order may indicate that the 1^{st} slat is composed of walnut, 2^{nd} slat is composed of cherry, 3^{rd} slat is composed of hickory, 4^{th} and 5^{th} slats are composed of walnut, and 6^{th}, 7^{th}, and 8^{th} slats are composed of maple.

Desired pattern module 812 may work in conjunction with the slat information module 810 and/or the work order module 808 and may be configured to determine the desired pattern/arrangement of the plurality of slats. In some cases, the desired pattern module 812 can provide the plurality of slats to the user in the order indicated in the customer's work order, which can help decrease the likelihood of user error and/or optimize manufacturing time, as compared to the prior art. For instance, if the work order indicates that the 1^{st} slat is composed of walnut, 2^{nd} slat is composed of cherry, 3^{rd} slat is composed of hickory, 4^{th} and 5^{th} slats are composed of walnut, and 6^{th}, 7^{th}, and 8^{th} slats are composed of maple, the desired pattern module 812 can be configured to provide the user with the slats in that particular order.

Slat arrangement module 814 may be configured to assemble an intermediate workpiece, based at least in part on receiving the work order. In some cases, the slat arrangement module 814 may be configured to arrange the plurality of slats on a work bench (e.g., work bench described in relation to FIGS. 1 and/or 2), where the arrangement is based at least in part on the desired pattern. In other cases, the slat arrangement module 814 can be configured to display a rendering or illustration of the custom workpiece to be manufactured to the user, which can help the user ensure that the workpiece will be manufactured per customer specifications (e.g., help ensure that slat arrangement/design, type of wood, number of slats, type of workpiece, etc., is accurate).

Adhesive application module 816 may be configured to apply an adhesive on at least one surface of each of the plurality of slats, as previously described in relation to FIG. 4. In some cases, the adhesive application module 816 may be configured to control one or more rollers, applicators, etc., that can be used for applying an adhesive (or glue) on one or more exterior surfaces of the slats/panels. Alternatively, the adhesive application module 816 may be configured to automatically dispense the adhesive (or glue) to the user, where the amount of adhesive dispensed may be based on the specifications (e.g., number of slats) of the workpiece. In some instances, the adhesive application module 816 may be configured to visually analyze (e.g., using a camera and image recognition software) the slats and notify the user if there are any missed spots (i.e., no adhesive), adhesive layer is uneven, etc., which can help enhance the quality and durability of the finished workpiece.

Affixing module 818 may be configured to affix, based on applying the adhesive, each of the plurality of slats to at least one adjacent slat to form the intermediate workpiece.

Pressure application module 820 may be configured to apply pressure (e.g., horizontal pressure as described with reference to FIG. 3A, vertical pressure as described with reference to FIG. 3B) on the intermediate workpiece using a plurality of securing mechanisms (e.g., plurality of pipe clamps, one or more G clamps or C clamps, etc.). In some cases, the pressure application module 820 applies a horizontal pressure on the intermediate workpiece for a pre-defined duration (e.g., 1 hr., 2 hrs., etc.). In some cases, the pressure application module 820 may be configured to automatically control a pipe clamp system (e.g., electrically controlled pipe clamp system) to apply a horizontal pressure on the intermediate workpiece. Furthermore, the user may input the horizontal pressure that should be applied on the workpiece. Alternatively, the pressure application module 820 may automatically determine the amount of pressure that should be applied to affix the slats, for instance, based on the work order specifications. In one non-limiting example, the pressure application module 820 may apply pressure for a longer duration when the workpiece is larger (e.g., 12 or 16 slats) as compared to when the workpiece is smaller (e.g., 6 or 8 slats).

Processing module 822 may be configured to process the intermediate workpiece to form a finished workpiece, wherein the processing comprises at least processing the intermediate workpiece through one or more of a planer, a sander, and a jointer planer, based at least in part on applying the pressure on the intermediate workpiece. In some embodiments, the processing module 822 (or another module of the system 800) may be configured to control one or more of the planer, sander, and/or the jointer planer, in accordance with various aspects of the disclosure.

In some implementations, server(s) 802, client computing platform(s) 804, and/or external resources 830 may be operatively linked via one or more electronic communication links. For example, such electronic communication links may be established, at least in part, via a network 850 such as the Internet and/or other networks. It will be appreciated that this is not intended to be limiting, and that the scope of this disclosure includes implementations in which server(s) 802, client computing platform(s) 804, and/or external resources 830 may be operatively linked via some other communication media.

A given client computing platform 804 may include one or more processors configured to execute computer program modules. The computer program modules may be configured to enable an expert or user associated with the given client computing platform 804 to interface with system 800 and/or external resources 830, and/or provide other functionality attributed herein to client computing platform(s) 804. By way of non-limiting example, the given client computing platform 804 may include one or more of a desktop computer, a laptop computer, a handheld computer, a tablet computing platform, a NetBook, a Smartphone, and/or other computing platforms.

External resources 830 may include sources of information outside of system 800, external entities participating with system 800, and/or other resources. In some implementations, some or all of the functionality attributed herein to external resources 830 may be provided by resources included in system 800.

Server(s) 802 may include electronic storage 832, one or more processors 834, and/or other components. Server(s) 802 may include communication lines, or ports to enable the exchange of information with a network and/or other computing platforms. Illustration of server(s) 802 in FIG. 8 is not intended to be limiting. Server(s) 802 may include a plurality of hardware, software, and/or firmware components operating together to provide the functionality attributed herein to server(s) 802. For example, server(s) 802 may be implemented by a cloud of computing platforms operating together as server(s) 802.

Electronic storage 832 may comprise non-transitory storage media that electronically stores information. The electronic storage media of electronic storage 832 may include one or both of system storage that is provided integrally (i.e., substantially non-removable) with server(s) 802 and/or removable storage that is removably connectable to server(s) 802 via, for example, a port (e.g., a USB port, a firewire port, etc.) or a drive (e.g., a disk drive, etc.). Electronic storage 832 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 832 may include one or more virtual storage resources (e.g., cloud storage, a virtual private network, and/or other virtual storage resources). Electronic storage 832 may store software algorithms, information determined by processor(s) 834, information received from server(s) 802, information received from client computing platform(s) 804, and/or other information that enables server(s) 802 to function as described herein.

Processor(s) 834 may be configured to provide information processing capabilities in server(s) 802. As such, processor(s) 834 may include one or more of a digital processor, an analog processor, a digital circuit designed to process information, an analog circuit designed to process information, a state machine, and/or other mechanisms for electronically processing information. Although processor(s) 834 is shown in FIG. 8 as a single entity, this is for illustrative purposes only. In some implementations, processor(s) 834 may include a plurality of processing units. These processing units may be physically located within the same device, or processor(s) 834 may represent processing functionality of a plurality of devices operating in coordination. Processor(s) 834 may be configured to execute modules 808, 810, 812, 814, 816, 818, 820, and/or 822, and/or other modules. Processor(s) 834 may be configured to execute modules 808, 810, 812, 814, 816, 818, 820, and/or 822, and/or other modules by software; hardware; firmware; some combination of software, hardware, and/or firmware; and/or other mechanisms for configuring processing capabilities on processor(s) 834. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 808, 810, 812, 814, 816, 818, 820, and/or 822 are illustrated in FIG. 8 as being implemented within a single processing unit, in implementations in which processor(s) 834 includes multiple processing units, one or more of modules 808, 810, 812, 814, 816, 818, 820, and/or 822 may be implemented remotely from the other modules. The description of the functionality provided by the different modules 808, 810, 812, 814, 816, 818, 820, and/or 822 described below is for illustrative purposes, and is not intended to be limiting, as any of modules 808, 810, 812, 814, 816, 818, 820, and/or 822 may provide more or less functionality than is described. For example, one or more of modules 808, 810, 812, 814, 816, 818, 820, and/or 822 may be eliminated, and some or all of its functionality may be provided by other ones of modules 808, 810, 812, 814, 816, 818, 820, and/or 822. As another example, processor(s) 834 may be configured to execute one or more additional modules that may perform some or all of the functionality attributed below to one of modules 808, 810, 812, 814, 816, 818, 820, and/or 822.

Some methods described in connection with the embodiments disclosed herein may be embodied directly in hardware, in processor-executable code encoded in a non-transitory tangible processor readable storage medium, or in a combination of the two. Referring to FIG. 7 for example, shown is a block diagram of a computer system 700 depicting physical components that may be utilized to realize the system 800 according to an exemplary embodiment. As shown, in this embodiment a display portion 712 and nonvolatile memory 720 are coupled to a bus 722 that is also coupled to random access memory (“RAM”) 724, a processing portion (which includes N processing components) 726, an optional field programmable gate array (FPGA) 727, and a transceiver component 728 that includes N transceivers. Although the components depicted in FIG. 7 represent physical components, FIG. 7 is not intended to be a detailed hardware diagram; thus, many of the components depicted in FIG. 7 may be realized by common constructs or distributed among additional physical components. Moreover, it is contemplated that other existing and yet-to-be developed physical components and architectures may be utilized to implement the functional components described with reference to FIG. 7.

This display portion 712 generally operates to provide a user interface (e.g., website, mobile app, web app) for a user/customer, and in several implementations, the display is realized by a touchscreen display. In general, the nonvolatile memory 720 is non-transitory memory that functions to store (e.g., persistently store) data and processor-executable code (including executable code that is associated with effectuating the methods described herein). In some embodiments for example, the nonvolatile memory 720 includes bootloader code, operating system code, file system code, and non-transitory processor-executable code to facilitate the execution of a method described with reference to FIGS. 5 and/or 6 described further herein.

In many implementations, the nonvolatile memory 720 is realized by flash memory (e.g., NAND or ONENAND memory), but it is contemplated that other memory types may be utilized as well. Although it may be possible to execute the code from the nonvolatile memory 720, the executable code in the nonvolatile memory is typically loaded into RAM 724 and executed by one or more of the N processing components in the processing portion 726.

The N processing components in connection with RAM 724 generally operate to execute the instructions stored in nonvolatile memory 720 to enable one or more operations described in relation to FIGS. 5 and/or 6. For example, non-transitory, processor-executable code to effectuate the methods described with reference to FIG. 6 may be persistently stored in nonvolatile memory 720 and executed by the N processing components in connection with RAM 724. As one of ordinarily skill in the art will appreciate, the processing portion 726 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 726 may be configured to effectuate one or more aspects of the methodologies described herein (e.g., the method described with reference to FIG. 6). For example, non-transitory processor-readable instructions may be stored in the nonvolatile memory 720 or in RAM 724 and when executed on the processing portion 726, cause the processing portion 726 to perform one or more of the operations described with reference to FIG. 6. Alternatively, non-transitory FPGA-configuration-instructions may be persistently stored in nonvolatile memory 720 and accessed by the processing portion 726 (e.g., during boot up) to configure the hardware-configurable portions of the processing portion 726 to effectuate the functions of the system 800 configured for manufacturing workpieces.

The input component 730 operates to receive signals (e.g., a work order, a desired pattern for the slats, a number of slats, a type of material for each slat, a horizontal and/or vertical pressure that should be applied to the workpiece, etc.) that are indicative of one or more aspects of the custom workpiece to be manufactured. The output component 732 generally operates to provide one or more analog or digital signals to effectuate an operational aspect of a work bench, an automatic adhesive applicator, a computer-controlled pipe clamp (or another securing mechanism), a computer-controlled planer, a computer-controlled sander, and/or a computer-controlled jointer planer, to name a few non-limiting examples. For example, the output component 732 may provide the amount of pressure to be applied on the intermediate workpiece, as described with reference to FIGS. 6 and/or 8.

The depicted transceiver component 728 includes N transceiver chains, which may be used for communicating with external devices via wireless or wireline networks (e.g., network 850 in FIG. 8). Each of the N transceiver chains may represent a transceiver associated with a particular communication scheme (e.g., Wi-Fi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like may refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present disclosure may be embodied as a system, method, apparatus, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A work bench, comprising:
a frame comprising,
a flat surface, and
a stand coupled to, and positioned below, the flat surface;
a plurality of spacers, wherein each of the plurality of spacers is mounted along one of a first edge of the flat surface or a second, opposing edge of the flat surface; and
a plurality of securing mechanisms; and
wherein,
each of the plurality of securing mechanisms is arranged at an elevated position with respect to the flat surface, and
each of the plurality of securing mechanisms comprises,
a plurality of clamps, including at least a first clamp and a second clamp, and
a rod extending between the first edge of the flat surface and the second, opposing edge of the flat surface,
the rod is shaped and sized to extend into a hole in each of the first and the second clamps,
the first clamp is coupled to a tightening mechanism and the second clamp is slidable along a length of the rod, and
the work bench is configured to enable one or more users to work on a plurality of workpieces in parallel, based at least in part on:
supporting the plurality of workpieces on the plurality of rods, and
securing each of the plurality of workpieces between at least the first clamp and the second clamp of a respective securing mechanism.

2. The work bench of claim 1, wherein securing each of the plurality of workpieces further comprises:
positioning a respective workpiece such that at least one first clamp of at least one of the plurality of securing mechanisms abuts a first surface of the workpiece;
sliding at least one second clamp of the at least one of the plurality of securing mechanisms such that the at least one second clamp abuts a second surface of the workpiece; and
adjusting at least one tightening mechanism coupled to the at least one first clamp to apply pressure on the respective workpiece in a direction that is substantially parallel to the flat surface of the work bench.

3. The work bench of claim 1, wherein each of the plurality of spacers is positioned underneath one of a first angle iron and a second angle iron, and wherein the first angle iron is arranged along the first edge of the flat surface and the second angle iron is arranged along the second edge of the flat surface.

4. The work bench of claim 3, wherein each of the plurality of securing mechanisms is coupled at one end to the first angle iron and at a second, opposing end to the second angle iron.

5. The work bench of claim 1, wherein the flat surface is substantially rectangular in shape and further comprises:
a third edge; and
a fourth edge opposing the third edge.

6. The work bench of claim 5, wherein the plurality of securing mechanisms comprise a plurality of pipe clamps extending between the first and second edges of the flat surface.

7. The work bench of claim 6, wherein the plurality of pipe clamps are oriented in a direction that is substantially parallel to the third and fourth edges of the flat surface.

8. The work bench of claim 1, wherein the spacers are configured to provide sufficient clearance between the flat surface and a respective underside of one or more of the plurality of workpieces to enable one or more vertically oriented clamps to apply downward pressure on the one or more workpieces.

9. The work bench of claim 8, wherein the one or more vertically oriented clamps comprise one or more C-clamps, G-clamps, and G-cramps.

10. The work bench of claim 1, where supporting the plurality of workpieces on the plurality of rods further comprises:
supporting a first workpiece on at least a first rod and a second rod of the plurality of rods;
supporting a second workpiece on at least the first rod and the second rod of the plurality of rods;
supporting a third workpiece on at least a third rod and a fourth rod of the plurality of rods; and
supporting a fourth piece on at least a fifth rod and a sixth rod of the plurality of rods.

11. The work bench of claim 10, wherein:
the first workpiece and the second workpiece are positioned adjacent different ones of the first and the second edges of the flat surface;
the third workpiece is adjacent one of the first or the second workpiece; and
at least two of the first, second, third, and fourth workpieces have different dimensions.

12. A method for forming workpieces, comprising:
providing a plurality of slats;
arranging the plurality of slats on a work bench, the work bench comprising:
a flat surface,
a plurality of securing mechanisms configured to extend between two opposing edges of the flat surface, wherein each of the plurality of securing mechanisms comprises a rod and a plurality of clamps, and
a clearance or gap between the flat surface and the plurality of securing mechanisms;
applying an adhesive on at least one surface of each of the plurality of slats;
affixing, based on applying the adhesive, each of the plurality of slats to at least one adjacent slat to form an intermediate workpiece;
applying pressure on the intermediate workpiece using the plurality of securing mechanisms; and
processing the intermediate workpiece to form a finished workpiece, wherein the processing is based at least in part on applying the pressure on the intermediate workpiece, and wherein the processing comprises at least:
processing the intermediate workpiece through one or more of a planer, a sander, and a jointer planer.

13. The method of claim 12, wherein the finished workpiece is composed of one or more types of wood, and wherein the finished workpiece comprises one of a cutting board, a charcuterie board, a rolling tray, a pastry board, and a game board.

14. The method of claim 12, wherein processing the intermediate workpiece further comprises:
treating the intermediate workpiece; and
smoothing or sanding down the intermediate workpiece, based at least in part on the treating.

15. The method of claim 14, wherein:
the intermediate workpiece is composed of one or more types of wood;
the intermediate workpiece is treated a plurality of times, and wherein the treating comprising applying a mixture of water and oil on one or more surfaces of the intermediate workpiece; and
the intermediate workpiece is smoothed or sanded down after each treatment.

16. The method of claim 15, wherein a different grit or roughness level is utilized to smooth or sand down the intermediate workpiece after each treatment.

17. The method of claim 16, further comprising smoothing or sanding down the intermediate workpiece using a coarser grit before a finer grit.

18. The method of claim 15, wherein the treatment allows grains of wood on the intermediate workpiece to rise, and wherein the smoothing or sanding down after each treatment assists in creating a smooth finish on the finished workpiece by scraping the raised grains of wood on the intermediate workpiece.

19. A system configured for manufacturing custom workpieces, comprising:
one or more hardware processors configured by machine-readable instructions to:
receive a work order from a customer, wherein the work order comprises information pertaining to a plurality of slats of a custom workpiece, the information comprising:
an indication of a number of slats
an indication of a type of material for each slat of the plurality of slats, and
a desired pattern, wherein the desired pattern corresponds to an arrangement of the plurality of slats;
assemble an intermediate workpiece, based at least in part on receiving the work order, wherein the assembling comprises:
arranging the plurality of slats on a work bench, based on the desired pattern,
applying an adhesive on at least one surface of each of the plurality of slats, and
affixing, based on applying the adhesive, each of the plurality of slats to at least one adjacent slat to form the intermediate workpiece;
apply pressure on the intermediate workpiece using a plurality of securing mechanisms; and
process the intermediate workpiece to form a finished workpiece, wherein the processing is based at least in part on applying the pressure on the intermediate workpiece, and wherein the processing comprises at least:
processing the intermediate workpiece through one or more of a planer, a sander, and a jointer planer.

20. The system of claim 19, wherein
the finished workpiece comprises one of a cutting board, a charcuterie board, a rolling tray, and a game board;
each of the plurality of slats is composed of wood;
receiving the indication of the type of material for each slat of the plurality of slats comprises receiving an indication of a type of wood for each of the plurality of slats; and
the type of wood is selected from a group consisting of sapele, maple, hickory, cherry, padauk, purpleheart, and walnut.
